(19) United States
(12) Patent Application Publication
(10) Pub. No.: US 2017/0012540 A1
(43) Pub. Date: Jan. 12, 2017

(54) POWER SUPPLY APPARATUS AND METHOD FOR CONTROLLING CONVERTER

(71) Applicant: Samsung Electro-Mechanics Co., Ltd., Suwon-si (KR)

(72) Inventors: In Wha JEONG, Suwon-si (KR); Jae Suk SUNG, Suwon-si (KR); Hugh KIM, Suwon-si (KR)

(73) Assignee: Samsung Electro-Mechanics Co., Ltd., Suwon-si (KR)

(21) Appl. No.: 15/079,866

(22) Filed: Mar. 24, 2016

(30) Foreign Application Priority Data
Jul. 8, 2015 (KR) 10-2015-0097430

(51) Int. Cl. H02M 3/335; H02M 1/44; H02M 1/14; H02M 1/42

(52) U.S. Cl. CPC H02M 3/33507; H02M 1/42; H02M 1/44; H02M 1/14

(57) ABSTRACT

A power supply apparatus includes: converters configured to switch an input power to convert the input power into a total direct current (DC) power; and a controller configured to control DC power-to-total DC power ratios of the converters based on at least one of whether or not the converters are operated or operation temperatures of the converters.

### CROSS-REFERENCE TO RELATED APPLICATION(S)

This application claims the benefit under 35 USC 119(a) of Korean Patent Application No. 10-2015-0097430, filed on Jul. 8, 2015 in the Korean Intellectual Property Office, the entire disclosure of which is incorporated herein by reference for all purposes.

### BACKGROUND

1. Field

The following description relates to a power supply apparatus and a method for controlling a converter.

2. Description of Related Art

Generally, a power supply apparatus converts input power into a specific direct current (DC) voltage using a converter and supplies the DC voltage. In order to provide element protection, reliability of operation, and energy efficiency of the power supply apparatus and a target to which power is to be supplied, a level of the supplied DC voltage needs to be stable.

Recently, as power supply apparatuses have been implemented in various products, an operation environment of the power supply apparatus has not been sufficient. For example, in a case in which the power supply apparatus is used in an on-board charger for an electric two-wheeled vehicle or another electric vehicle, a variation in an internal temperature of the power supply apparatus may be greater than that found in most cases. Therefore, a power supply apparatus capable of stably supplying DC voltage even when the internal temperature is significantly varied is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a power supply apparatus includes: converters configured to switch an input power to convert the input power into a total direct current (DC) power; and a controller configured to control DC power-to-total DC power ratios of the converters based on at least one of whether the converters are operated or operation temperatures of the converters.

The input power may be common to all of the converters, the total DC power may be a predetermined DC power, and output terminals of the converters may be connected to one another such that DC powers output from each of the converters are summed and then output as the total DC power.

Each of the converters may include: a transformer; a switching circuit connected to a primary side of the transformer and configured to switch the input power; and a rectifying circuit connected to a secondary side of the transformer and configured to rectify a transformed power.

The controller may be further configured to sense whether the converters are operated or sense the operation temperatures of the converters based on a current flowing in at least one of the transformer, the switching circuit, or the rectifying circuit.

The controller may be configured to sense the operation temperatures of the converters and perform control such that the DC power-to-total DC power ratios are non-uniform, in response to the operation temperature of at least one of the converters being higher than a preset temperature.

The controller may be configured to regulate the DC power-to-total DC power ratios to reduce the total DC power while maintaining a total voltage output from the converters when the controller performs the control such that the DC power-to-total DC power ratios are non-uniform.

The controller may be configured to perform control such that, in response to at least one converter, among the converters, not being operated, a level of DC power output by at least one other converter, among the converters, is increased.

The power supply apparatus may further include a power factor correcting circuit connected to input terminals of the converters and configured to correct a power factor of alternating current (AC) power.

The power supply apparatus may further include a regulator connected to output terminals of the converters and configured to regulate a level of power supplied by the power supply apparatus.

According to another general aspect, a method for controlling converters includes: sensing whether converters are operated, or sensing operation temperatures of the converters; and controlling DC power-to-total DC power ratios of the converters based on at least one of whether the converters are operated or the operation temperatures of the converters.

The sensing of whether the converters are operated or the operation temperatures of the converters is based on sensing currents of input terminals or output terminals of the converters.

The method may include sensing the operation temperatures of the converters, wherein the controlling of the DC power-to-total DC power ratios of the converters includes performing control such that the DC power-to-total DC power ratios are non-uniform in response to the operation temperature of at least one of the converters being higher than a preset temperature.

The performing of the control such that the DC power-to-total DC power ratios are non-uniform may include regulating the DC power-to-total DC power ratios to reduce a total DC power of the converters while maintaining a total voltage output from the converters.

The performing of the control may include stopping an operation of the at least one converter and increasing a level of DC power converted in at least one of the other converters.

According to another general aspect, a power supply apparatus includes: converters configured to receive an input power and generate respective output voltages in order to generate respective direct current (DC) powers; and a controller configured to reduce the respective output voltage of at least one converter, among the converters, that has an operation temperature that is higher than a preset temperature, and increase the respective output voltage of at least one other converter, among the converters.

The power supply apparatus may be configured to sum the respective DC powers to output a total DC power, and maintain the total DC power within a specified range.

The power supply apparatus may be configured to sum the respective output voltages to generate a total output voltage, and maintain the total output voltage at a same level.

Other features and aspects will be apparent from the following detailed description, the drawings, and the claims.

### BRIEF DESCRIPTION OF THE DRAWINGS

FIG. 1 is a view illustrating a power supply apparatus, according to an embodiment.

FIG. 2 is a view illustrating converters of FIG. 1 in detail, according to an embodiment.

FIGS. 3A and 3B are views illustrating an amplitude change of voltages converted in the converters by a control of a controller of FIG. 1, according to an embodiment.

FIG. 4 is a view illustrating a principle in which the controller of FIG. 1 controls voltages converted in the converters to be non-uniform, according to an embodiment.

FIG. 5 is a view illustrating the power supply apparatus of FIG. 1 in detail, according to an embodiment.

FIG. 6 is a circuit diagram illustrating the power supply apparatus of FIG. 1 in detail, according to an embodiment.

FIG. 7 is a flow chart illustrating a method for controlling converters, according to an embodiment.

FIG. 8 is a flow chart illustrating, according to a more detailed embodiment, the method of FIG. 7 for controlling the converters.

FIG. 9 is a view illustrating an example of a computing environment in which one or more embodiments disclosed herein may be implemented.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

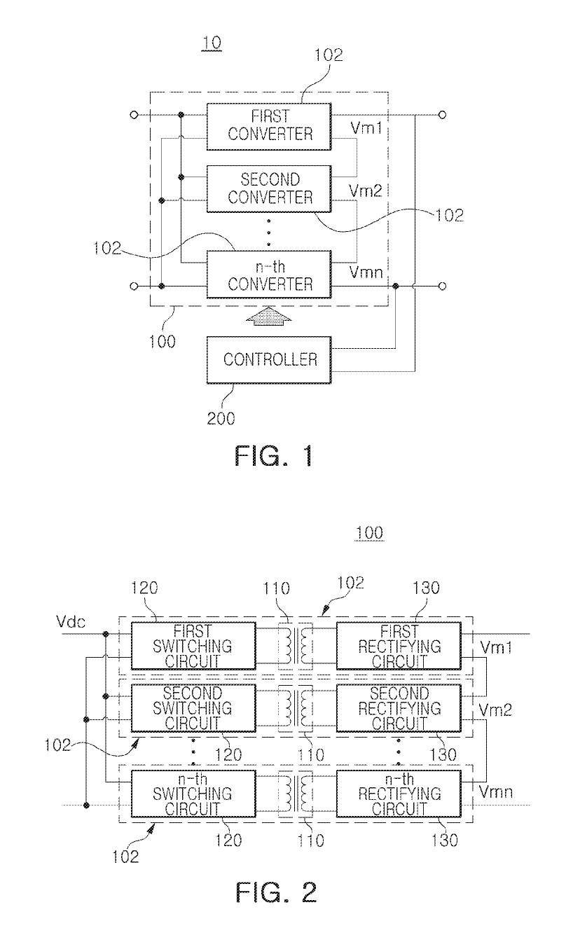

FIG. 1 is a view illustrating a power supply apparatus 10, according to an embodiment. Referring to FIG. 1, the power supply apparatus 10 includes a converter group 100 and a controller 200.

The converter group 100 includes a first converter 102, a second converter 102 and any number of additional converters up to an n^{th} converter 102. In an alternative embodiment, for example, the converter group 100 may include only the first and second converters 102. The converter group 100 switches an input power to convert the input power into predetermined direct current (DC) power. The input power may be alternating current (AC) power or DC power. For example, each of the converters 102 may be a half-bridge type, full-bridge type, or phase-shift full-bridge type LCC resonance circuit, and may be designed to have high efficiency with respect to a wide range of impedance change.

The higher the switching frequency of the converters 102 is, the smaller the size of the converters 102 will be. However, as the size of the converters 102 becomes small, high frequency switching loss and transformation loss may occur in the converters 102, which may be problematic. These may cause a reduction in efficiency of the converters 102.

The high frequency switching loss and transformation loss may be reduced by role division of the converters 102. For example, the converters 102 convert common input power into predetermined DC power, and output terminals of the converters 102 are connected to each other so that DC power output from respective converters (the first converter 102, the second converter 102,..., and the n^{th} converter 102) is summed up and then output. That is, input terminals of the converters 102 are connected to one another in parallel, and the output terminals of the converters 102 are connected to one another in series. Therefore, voltages treated by elements performing a switching operation or a transformation operation in the converters 102 may be reduced, and thus the switching loss and transformation loss may be reduced.

Operation states or operation environments of the converters 102 may be different from each other. For example, optimal operation conditions of the converters 102 may be determined depending on positions at which the converters 102 are mounted, and depending on an internal cooling condition of a sealed on-board charger.

That is, since spaces in which the converters 102 are physically disposed are different from one another, even in a case in which specifications of the converters 102 are the same as one another, powers converted by the converters 102 may be slightly different from one another. For example, in a case in which an internal temperature of one of the converters 102 is higher than the internal temperatures of the other converters 102, DC power converted by the converter of which the internal temperature is higher may be significantly deviated from a reference power.

The controller 200 controls the DC power-to-total DC power ratio of each of the converters 102 on the basis of whether or not the converters 102 are being operated or depending on the operation environments of the converters 102. For example, in the case in which the internal temperature of one of the converters 102 is higher than the internal temperatures of the other converters 102, the controller 200 may perform a control to stop an operation of the converter 102 of which the internal temperature is higher and increase DC power converted in the other converters 102. Therefore, the sum of the DC power converted in the converter group 100 may be controlled to remain within a specified range.

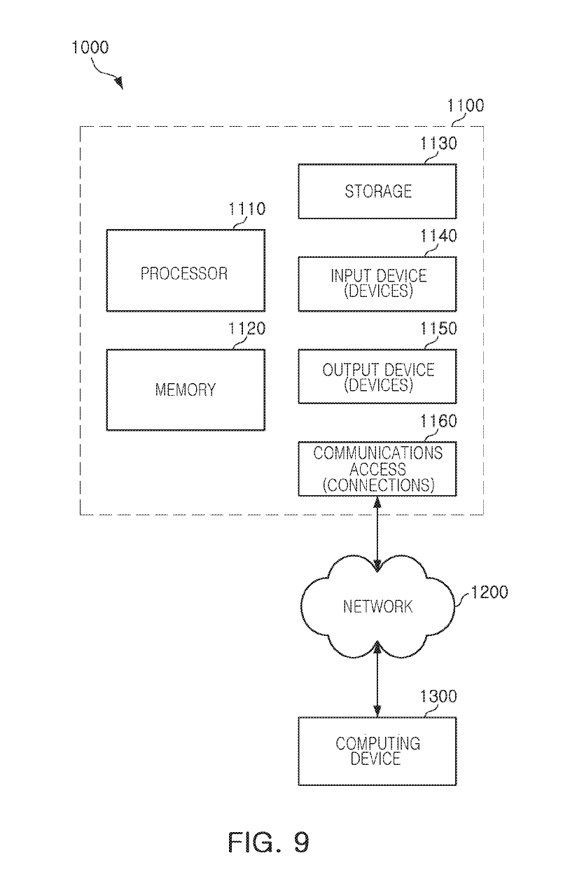

For example, the controller 200 senses temperatures of the converters 102, and performs a control so that the output voltage ratios of the converters 102 are non-uniform in a case in which a temperature of at least one of the converters 102 is higher than a preset temperature. That is, output voltages of the converters 102 are not always fixed to the same value, and may be changed on the basis of temperature states, or the like, of the converters 102. In a case in which a temperature of a specific converter is high, the controller 200 lowers an output voltage of the corresponding converter 102 to alleviate an output burden, thereby significantly reducing thermal stress of the converter group 100. A detailed method of implementing the controller 200 will be described below with reference to FIG. 9.

FIG. 2 is a view illustrating the converters 102 of FIG. 1 in detail, according to an embodiment. Referring to FIG. 2, each converter 102 includes a transformer 110, a switching circuit 120, and a rectifying circuit 130. Thus, the first converter 102 includes a first transformer 110, a first switching circuit 120, and a first rectifying circuit 130. The second converter 102 includes a second transformer 110, a second switching circuit 120, and a second rectifying circuit 130. The n^{th} converter 102 includes an n^{th} transformer 110, an n^{th} switching circuit 120, and an n^{th} rectifying circuit 130.

The transformer 110 transforms a voltage of its primary side and transfers the transformed voltage to its secondary side. For example, the transformer 110 includes a primary coil (on the primary side) and a secondary coil (on the secondary side) that are electromagnetically coupled to each other. Alternatively, the transformer 110 may be a piezoelectric transformer.

The switching circuit 120 is connected to the primary side of the transformer 110 to switch an input power. For example, the switching circuit 120 includes semiconductor elements of which turned-on/off states are controlled in a pulse width modulation (PWM) scheme by gate terminals. The turned-on/off states of the semiconductor elements are repeated depending on a specific switching frequency. For example, the specific switching frequency may be a high frequency of about 1 MHz.

The rectifying circuit 130 is connected to the secondary side of the transformer 110 to rectify a voltage of the secondary side of the transformer 110. For example, the rectifying circuit 130 may include a half-wave rectifier, a full-wave rectifier, or a synchronous rectifier.

Temperatures of the converters 102 are sensed through a current flowing in at least one of the transformer 110, the switching circuit 120, and the rectifying circuit 130. For example, in the case in which a magnitude of a current flowing in the rectifying circuit 130 is greater than the magnitude of a current flowing in the switching circuit 120, the temperature may be confirmed on the basis of the current flowing in the rectifying circuit 130. Generally, a characteristic of a semiconductor circuit is that temperature and current are in proportion to each other in a specific temperature range. Through this, the temperatures of the converters 102 can be predicted. The temperatures of the converters 102 may be sensed through an additional circuit such as a temperature sensor.

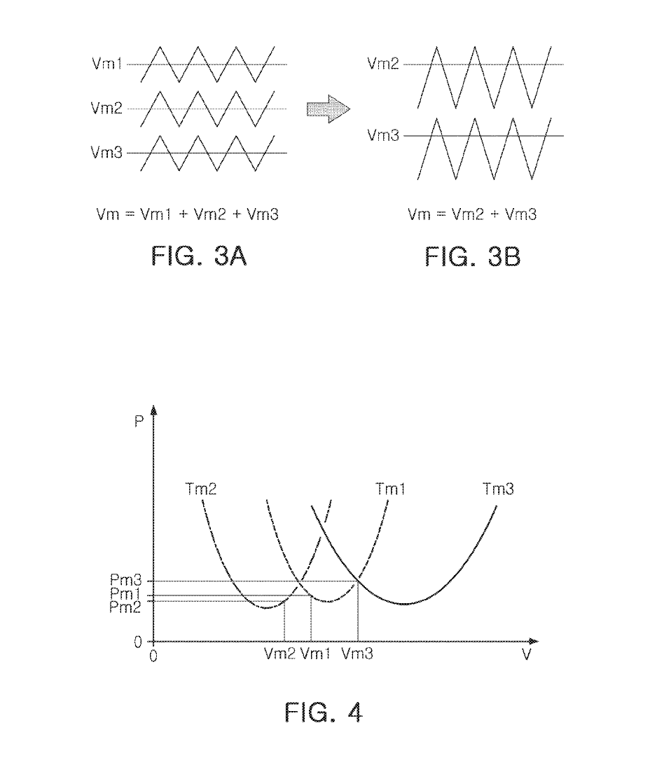

FIGS. 3A and 3B are views illustrating an amplitude change of voltages converted in the converters 102 by control of the controller 200, according to an embodiment.

Referring to FIG. 3A, in a case in which operation temperatures of the converters 102 are similar to each other, the converters 102 uniformly convert the input power into DC power. A DC voltage Vm corresponding to the sum of respective DC voltages Vm1, Vm2, and Vm3 of the converters 102 is output. Therefore, the respective first through n^{th} converters 102 significantly reduce switching loss and transformation loss.

Referring to FIG. 3B, in a case in which an operation temperature of one of the converters 102 is higher than the operation temperatures of the other converters 102, an operation of the converter 102 of which the operation temperature is high is stopped. DC voltages Vm2 and Vm3 output from the other converters 102 are increased. The DC voltages Vm2 and Vm3 output from the other converters 102 are determined so that the DC voltage Vm corresponding to the sum of the DC voltages Vm2 and Vm3 output from the other converters 102 is not changed.

For example, in a case in which there are three converters 102, when an operation of one converter 102 is stopped, DC voltages output from the other converters 102 is 1.5 times the DC voltages output from the other converters 102 before the operation of the one converter 102 is stopped. Here, since a DC voltage output from one converter 102 is lower than the DC voltages output from the other two converters 102, the three converters 102 non-uniformly convert the input power into the DC power.

Each of the converters 102 may be designed so that a maximum output voltage thereof is the same as a total output voltage of the converter group 100. For example, in the case in which there are three converters 102, a maximum output voltage of each of the converters 102 is three times the output voltage each of the converters 102 in a normal operation.

Operations of the converters 102 may be defined as modes. For example, the operation illustrated in FIG. 3A may be defined as a normal operation mode. For another example, the operation illustrated in FIG. 3B may be defined as a fault tolerant operation mode.

FIG. 4 is a view illustrating a principle in which the controller 200 controls voltages converted in the converters 102 to be non-uniform. Referring to FIG. 4, the horizontal axis V indicates a converted voltage, the vertical axis P indicates consumed power, and the curves indicate voltage-power curves depending on an operation temperature.

Generally, a voltage-power curve changes depending on an operation temperature of a converter. For example, a converter 102 operated at a first temperature Tm1 consumes a first power Pm1 when it outputs a first voltage Vm1, a converter 102 operated at a second temperature Tm2 consumes a second power Pm2 when it outputs a second voltage Vm2, and a converter 102 operated at a third temperature Tm3 consumes a third power Pm3 when it outputs a third voltage Vm3.

Therefore, in a case in which a temperature of each of the converters 102 is confirmed, an output voltage of each of the converters 102 is set so that power consumed by each of the converters 102 is reduced. For example, a voltage of a converter 102 having a voltage-power curve that is distributed toward the right may be set to be higher than a voltage of a converter 102 having a voltage-power curve that is distributed toward the left, in relation to the graph of FIG. 4. Therefore, the sum of the powers consumed by the converters 102 is significantly reduced, while the sum of the voltages output from the converters 102 is maintained as a specific preset voltage.

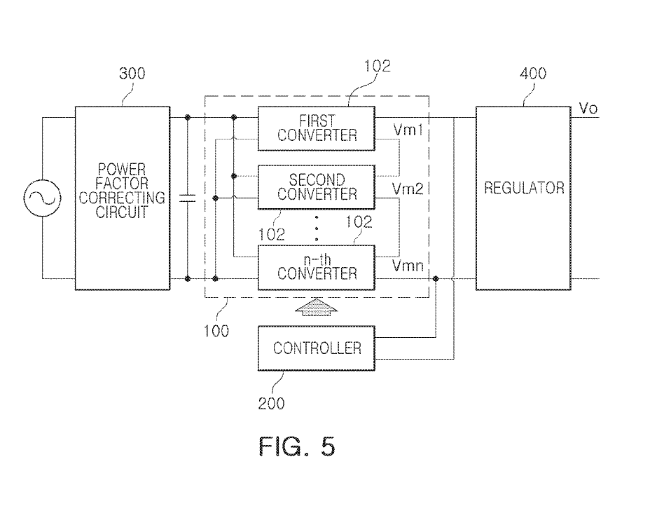

FIG. 5 is a view illustrating the power supply apparatus 10 of FIG. 1 in detail, according to an embodiment. Referring to FIG. 5, the power supply apparatus 10 further includes a power factor correcting circuit 300 and a regulator 400.

The power factor correcting circuit 300 is connected to the input terminals of the 102 to correct a power factor of AC power. For example, the power factor correcting circuit 300 is implemented by a two-phase interleaved boost power factor correcting circuit in order to reduce electromagnetic interference (EMI) noise, EMI filtering, and a size of a DC-link capacitor depending on a reduction in an input ripple current.

The regulator 400 is connected to the output terminals of the converter 100 and/or the controller 200 to regulate a level of a supplied power. For example, the sum Vm of the output voltages of the converters 102 is input to the regulator 400 to thereby be converted into a battery charging voltage determined by a battery charging algorithm. The regulator 400 may be operated as a buck regulator or may be operated as a boost regulator.

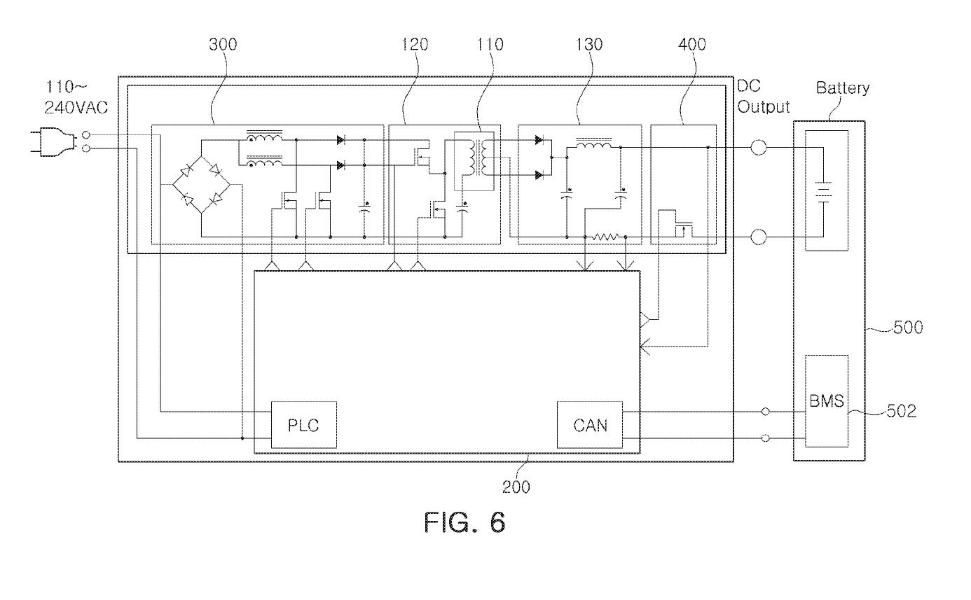

FIG. 6 is a circuit diagram illustrating the power supply apparatus 10 of FIG. 1 in detail, according to an embodiment.

Referring to FIG. 6, the power supply apparatus 10 includes the transformer 110, the switching circuit 120, the rectifying circuit 130, the controller 200, the power factor correcting circuit 300, and the regulator 400, and receives commercial power (110 to 240VAC) and supply the power to a battery 500. Although the rectifying circuit 130 is implemented by a diode rectifying circuit in FIG. 6, the rectifying circuit 130 may be implemented by a synchronous rectifying circuit in which a low loss switching element is used instead of a diode in order to significantly reduce diode conduction loss.

The controller 200 not only controls an operation of the converter 102, but also receives an external signal to perform control. For example, the controller 200 receives a signal depending on a battery charging control algorithm through a battery management system (BMS) 502 included in the battery 500. Therefore, the controller 200 more efficiently controls the converter 102.

A power supply apparatus may be utilized in a product that needs to be miniaturized and lightened, such as an on-board charger for an electric two-wheeled vehicle or another electric vehicle. Since the product as described above has a natural air-cooling sealed structure in which it is charged through general commercial power, a variation in an operation temperature may be significantly high. Therefore, reliability of operation of a converter may be deteriorated. However, the power supply apparatus 10, according to the embodiments disclosed herein can solve the problem of deteriorating reliability of operation of the converter 102, thereby stably supplying the power.

Hereinafter, a method for controlling converters 102, according to an embodiment, will be described. Content in the method for controlling the converters 102 that is the same as or corresponds to the content of the above description of the power supply apparatus 10 will be omitted in order to avoid an overlapping description.

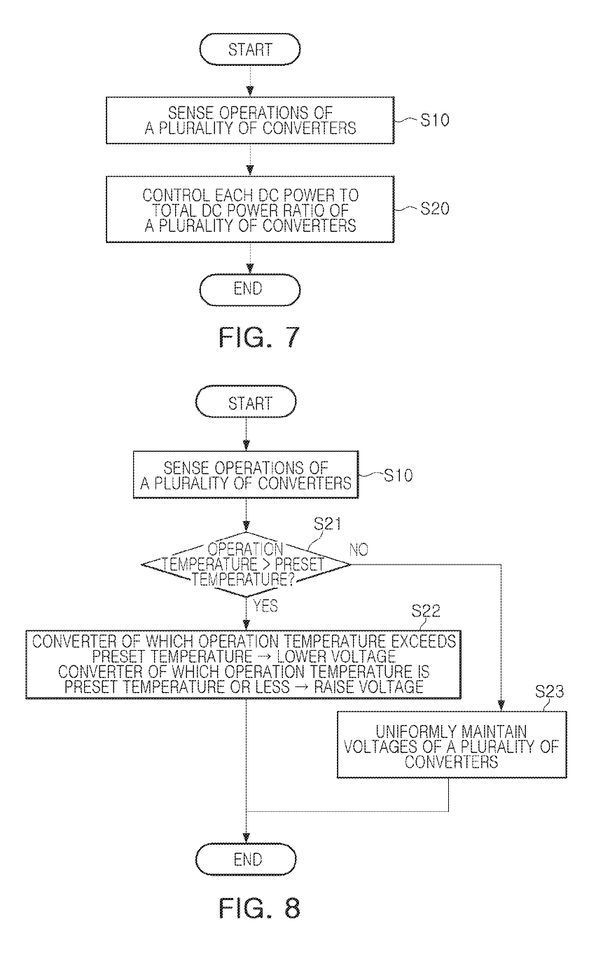

FIG. 7 is a flow chart illustrating a method for controlling converters 102, according to an embodiment. Referring to FIG. 7, the method for controlling the converters 102 includes a sensing operation S10 and a controlling operation S20.

In the sensing operation S10, the power supply apparatus 10 senses whether or not the converters 102 are operated, or senses operation environments of the converters 102. For example, in the sensing operation 510, currents of the input terminals or the output terminals of the converters are sensed, and whether or not the converters 102 are operated or the operation environments of the converters 102 is sensed based on the sensed currents.

In the controlling operation S20, the power supply apparatus 10 controls the DC power-to-total DC power ratios of the converters 102 based on whether or not the converters 102 are operated or the operation environments of the converters 102.

For example, in the controlling step S20, the power supply apparatus 10 senses the temperatures of the converters 102, and performs control so that the output voltage ratios of the converters 102 are non-uniform in a case in which a temperature of at least one of the converters 102 is higher than a preset temperature.

For example, in the controlling step S20, the power supply apparatus 10 performs control to stop an operation of the converter 102 of which the temperature is higher and increase levels of DC power converted in at least one of the other converters 102 in the case in which the temperature of the at least one of the converters 102 is higher than the preset temperature.

FIG. 8 is a flow chart illustrating, according to a more detailed embodiment, the method of FIG. 7 for controlling the converters 102. Referring to FIG. 8, in an operation S21 of the controlling operation S20, the operation temperatures of the respective converters 102 are compared to the preset temperature in order to determine whether or not the operation temperatures of the respective converters 102 are higher than the preset temperature. In operation S22, in a case in which the operation temperature of at least one converter 102 is higher than the preset temperature, a voltage of the corresponding converter 102 is lowered, and voltages of the other converters 102 are raised.

In operation S23, in a case in which all of the converters 102 have an operation temperature that is not higher than the preset temperature, voltages of all the converters 102 are uniformly maintained.

FIG. 9 is a view illustrating an illustrative computing environment or system 1000 in which one or more embodiments describe herein may be implemented. In FIG. 9, an example of the system 1000 includes a computing device 1100 implementing one or more of the above-mentioned embodiments. For example, the computing device 1100 may include a personal computer, a server computer, a handheld or laptop device, a mobile device (a mobile phone, a personal digital assistants (PDA), a media player, or the like), a multiprocessor system, a consumer electronic device, a mini computer, a mainframe computer, a distributed computing environment including any system or device described above, and the like, but is not limited thereto.

The computing device 1100 includes at least one processor 1110 and a memory 1120. The processor 1110 may include, for example, a central processing unit (CPU), a graphics processing unit (GPU), a microprocessor, an application specific integrated circuit (ASIC), a field programmable gate array (FPGA), or the like, and may have multiple cores. The memory 1120 may be a volatile memory (such as a random access memory (RAM), or the like), a non-volatile memory (such as a read only memory (ROM), a flash memory, or the like), or a combination thereof.

In addition, the computing device 1100 further includes a storage 1130. The storage 1130 may include a magnetic storage, an optical storage, or the like, but is not limited thereto. Computer-readable commands for implementing one or more embodiments are stored in the storage 1130, and other computer-readable commands for implementing an operating system, an application program, and the like, may also be stored in the storage 1130. The computer-readable commands stored in the storage 1130 are loaded into the memory 1120 in order to be executed by the processor 1110.

In addition, the computing device 1100 includes at least one input device 1140 and at least one output device 1150. The input device(s) 1140 may include, for example, a keyboard, a mouse, a pen, an audio input device, a touch input device, an infrared camera, a video input device, any other input device, or the like. In addition, the output device(s) 1150 may include, for example, one or more displays, a speaker, a printer, any other output device, or the like. In addition, in the computing device 1100, an input device or an output device included in another computing device may be used as the input device(s) 1140 or the output device(s) 1150.

In addition, the computing device 1100 includes at least one communications access 1160 so that it may communicate with another device (for example, a computing device 1300) through a network 1200. The communications access(es) 1160 may include a modem, a network interface card (NIC), an integrated network interface, a radio frequency transmitter/receiver, an infrared port, a universal serial bus (USB) access, or another interface for connecting the computing device 1100 to another computing device. In addition, the communications access(es) 1160 may include a wired connection or a wireless connection.

The respective components of the computing device 1100 described above may be interconnected through various interconnections (for example, a peripheral component interconnect (PCI), a USB, firmware (IEEE 1394), an optical bus structure, and the like) such as a bus, and the like, or may be interconnected by a network.

Terms “component”, “module”, “system”, “interface”, and the like, used in the present disclosure generally refer to a computer related entity, which is hardware or a combination of hardware and software. For example, the component may be a processor, an object, an executable structure and/or a computer, but is not limited thereto. One or more components may be present in the process and/or the executing thread, and the component may be localized on one computer or may be distributed between two or more computers.

As set forth above, a power supply apparatus stably supplies a DC voltage even if the internal temperature is significantly varied, reduces energy loss due to an increase in an operation frequency, may be miniaturized and lightened, and provides reliable operation.

The apparatuses, units, modules, devices, and other components (e.g., the converters 102, the controller 200, the regulator 400, the processor 1110, the memory 1120 and the storage 1130) illustrated in FIGS. 1, 2, 5, 6 and 9 that perform the operations described herein with respect to FIGS. 7 and 8 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 7 and 8. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 7 and 8 that perform the operations described herein with respect to FIGS. 1, 2, 5, 6 and 9 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMS, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A power supply apparatus comprising:
converters configured to switch an input power to convert the input power into a total direct current (DC) power; and
a controller configured to control DC power-to-total DC power ratios of the converters based on at least one of whether the converters are operated or operation temperatures of the converters.

2. The power supply apparatus of claim 1, wherein the input power is common to all of the converters, the total DC power is a predetermined DC power, and output terminals of the converters are connected to one another such that DC powers output from each of the converters are summed and then output as the total DC power.

3. The power supply apparatus of claim 1, wherein each of the converters includes:
a transformer;
a switching circuit connected to a primary side of the transformer and configured to switch the input power; and
a rectifying circuit connected to a secondary side of the transformer and configured to rectify a transformed power.

4. The power supply apparatus of claim 3, wherein the controller is further configured to sense whether the converters are operated or sense the operation temperatures of the converters based on a current flowing in at least one of the transformer, the switching circuit, or the rectifying circuit.

5. The power supply apparatus of claim 1, wherein the controller is configured to sense the operation temperatures of the converters and perform control such that the DC power-to-total DC power ratios are non-uniform, in response to the operation temperature of at least one of the converters being higher than a preset temperature.

6. The power supply apparatus of claim 5, wherein the controller is configured to regulate the DC power-to-total DC power ratios to reduce the total DC power while maintaining a total voltage output from the converters when the controller performs the control such that the DC power-to-total DC power ratios are non-uniform.

7. The power supply apparatus of claim 1, wherein the controller is configured to perform control such that, in response to at least one converter, among the converters, not being operated, a level of DC power output by at least one other converter, among the converters, is increased.

8. The power supply apparatus of claim 1, further comprising a power factor correcting circuit connected to input terminals of the converters and configured to correct a power factor of alternating current (AC) power.

9. The power supply apparatus of claim 1, further comprising a regulator connected to output terminals of the converters and configured to regulate a level of power supplied by the power supply apparatus.

10. A method for controlling converters, comprising:
sensing whether converters are operated, or sensing operation temperatures of the converters; and
controlling DC power-to-total DC power ratios of the converters based on at least one of whether the converters are operated or the operation temperatures of the converters.

11. The method of claim 10, wherein the sensing of whether the converters are operated or the operation temperatures of the converters is based on sensing currents of input terminals or output terminals of the converters.

12. The method of claim 10, comprising sensing the operation temperatures of the converters, wherein the controlling of the DC power-to-total DC power ratios of the converters comprises performing control such that the DC power-to-total DC power ratios are non-uniform in response to the operation temperature of at least one of the converters being higher than a preset temperature.

13. The method of claim 12, wherein the performing of the control such that the DC power-to-total DC power ratios are non-uniform comprises regulating the DC power-to-total DC power ratios to reduce a total DC power of the converters while maintaining a total voltage output from the converters.

14. The method of claim 12, wherein the performing of the control comprises stopping an operation of the at least one converter and increasing a level of DC power converted in at least one of the other converters.

15. A power supply apparatus comprising:
converters configured to receive an input power and generate respective output voltages in order to generate respective direct current (DC) powers; and
a controller configured to
reduce the respective output voltage of at least one converter, among the converters, that has an operation temperature that is higher than a preset temperature, and
increase the respective output voltage of at least one other converter, among the converters.

16. The power supply apparatus of claim 15, wherein the power supply apparatus is configured to sum the respective DC powers to output a total DC power, and maintain the total DC power within a specified range.

17. The power supply apparatus of claim 15, wherein the power supply apparatus is configured to sum the respective output voltages to generate a total output voltage, and maintain the total output voltage at a same level.
